(19) United States
(12) Patent Application Publication
(10) Pub. No.: US 2016/0189051 A1
(43) Pub. Date: Jun. 30, 2016

(54) METHOD OF CONDITIONALLY PROMPTING WEARABLE SENSOR USERS FOR ACTIVITY CONTEXT IN THE PRESENCE OF SENSOR ANOMALIES

(71) Applicant: Junayd Fahim Mahmood, Middletown, NY (US)

(72) Inventor: Junayd Fahim Mahmood, Middletown, NY (US)

(21) Appl. No.: 14/969,755

(22) Filed: Dec. 15, 2015

Related U.S. Application Data
(60) Provisional application No. 62/095,798, filed on Dec. 23, 2014.

(51) Int. Cl. G06N 7/00; G06F 1/16; G06N 99/00

(52) U.S. Cl. CPC G06N 7/005; G06N 99/005; G06F 1/163

(57) ABSTRACT

A system and method to establish probabilistic relationships between readings from personal device sensors and user-reported context based on the selective presentation of user facing prompts for context information that are conditionally triggered based in part on the presence anomalies in data harvested from the sensors. Responses to the user-facing prompts, and the statistical association of these responses to sensor data patterns provide for the subsequent assessment of a user's probable context based on the similarity of subsequently measured sensor data patterns to the patterns exhibited in samples for which contexts based on user responses have already been modeled. The establishment of statistical relationships between user-reported context and anomalous patterns in data harvested from sensors such as bio sensors, may also be applied to the recommendation of specific activities or behaviors a user could engage in that might yield similar sensor readings. User responses to context inquiries may also be a basis for enabling or scaling up the sensors' sampling rate.

### BACKGROUND

1. Field of the Invention

The invention relates to the interpretation and analysis of sensor data measured by personal mobile or wearable devices. More specifically, the invention anticipates a method and system of requesting and then associating information about an individual's context with anomalies in sensor data. These associations make it possible to establish statistical relationships between sensor readings and real-world contexts in uncontrolled, ambiguous or open-ended conditions that can be used to both interpret the immediate sensor readings and to infer subsequent context based on future sensor readings.

2. Description of the Related Art

Understanding the real world context of sensor readings is the key to meaningful interpretations of the data. While the expanding number, variety and quality of sensors in personal electronic devices makes quantifying an individual's physical and biological context more practical than ever, deriving meaning from the vast amount of data harvested from these sensors requires an understanding of the specific context of the sensor readings. For example, an elevated heart rate may be a neutral or positive indication when the user is engaged in physical exercise, but may not actually be positive if the context of the elevated heart rate is the use of a new medication. Automatically understanding the real implications of passive sensor readings can be extremely valuable and useful to human lives, however, the requisite level of context-specificity required to automatically and reliably derive meaning from sensor data can be difficult to achieve in the typically uncontrolled and open-ended nature of peoples' lives.

Today's personal devices already feature a variety of sensors and these capabilities are expanding. Conventional mobile devices feature a variety of solid state and software based physics and location sensors such as GPS, radio, ambient light, accelerometers and pressure sensors. Wearable devices such as smart watches expand upon the variety of sensors available in mobile devices and are capable of measuring information such as heart rate, skin temperature, galvanic skin conductivity, blood oxygen and others. Wearable devices such as smart-watches (or the mobile phones they are often paired to) can collect sensor measurements over long periods of time, storing this data and optionally transmitting this information to external servers.

The value of establishing context is well understood and broadly applied, however, current approaches have drawbacks. As implemented in software models, context is typically either pre-modeled or derived based on assumptions of user intent. With manual methods, the process of recording context is cumbersome because it is not selective. For the purposes of this document, we consider three main types of context assignment methods in prior art 1) derived: the user's activity context can be assumed because of an action that suggests the user's intent such as launching a jogging application on their phone. In this case, any sensor readings captured while the jogging application is open are assumed to be related to jogging 2) pre-modeled: an application may reference a finite set of pre-defined of models and any specific context assessments are automatic but limited to that pre-defined set. Other unknown contexts cannot be accounted for, other than assigning them an ‘unknown’ or ‘other’ category. The prior art cited in this application fall into this variety. 3) logged: any and all context may be captured in either real time or post-hoc but the capturing of those contexts is neither selective nor is it typically automatic. An example would be the health journals that are discussed below.

Software apps today which consume sensor data are rather un-sophisticated in terms of associating context to the readings. Consumer oriented software applications exist which access biometric data from personal device sensors to help users understand patterns in their own biological response to activities such as jogging, cycling, or even sleeping. In these cases, the activity context of the biometric measurements is known because users of these applications are typically required to indicate the type of activity they will be involved in and may also indicate the beginning and end of that activity. However, even in these cases of manually expressed context or in cases where context can be implied based on the users use of an activity-oriented app, other variables can exist which may influence the sensor readings during the sample but which are not identified or isolated, making it difficult to base open ended inferences on this data. It should be noted that some more sophisticated activity-oriented apps may use sensor readings to trigger user-facing prompts; for example, if a speed sensor indicates a speed that is inconsistent with jogging (i.e. standing still or moving at vehicle speeds) a jogging application may ask a user if they wish to indicate the end of the jogging activity. However, this conditional user-facing prompt to terminate a jogging activity relies on a pre-established relationship between speed sensor readings and the assumption that the user is engaging in jogging. Given that the jogging context is known, it is possible to apply absolute or ‘dumb’ upper and lower speed thresholds that are reasonable for the activity of jogging to allow the software to guess whether the user is still jogging and prompt the user appropriately. The user's responses to threshold-based prompts do not affect the future behavior of those prompts.

Technology advancements in the areas of machine learning and sensor analytics have begun to offer alternatives to self-reported context information in situations where the context may be ambiguous, but these approaches still rely on ‘training’ within a known context. By applying established mathematical models such as Bayesian Inference to data gathered from accelerometers, light sensors, barometric pressure and other sensors, researchers in this area have been able to develop models that can reliably distinguish between a limited set of real world activities such as climbing stairs or running. Although follow-on inferences can be automated once these models have been established, the models nevertheless require an initial ‘training’ period where data patterns are established within a controlled setting wherein the activity context is known. Despite advancements in sensor technologies and inferential techniques, it remains necessary to pre-establish contextual relationships for meaningful inferences based on sensor data to be possible. Unfortunately, pre-modeling every possible real-world context is wildly impractical.

Understanding a broader set of possible external factors that have an impact on health and biology is a primary concern of medical practitioners when recommending health and wellness treatments, but the methods they use can be cumbersome or error prone. During patient consultation, physicians often recommend that their patients keep health journals which allow the practitioner to speculate upon the relationship between the patient's self-reported activities and their health indices. Unlike the case described above wherein wearable device software applications are focused on a specific activity such as jogging, health journals are often open-ended in nature in the sense that they theoretically allow for the recording of any and all of the patient's conscious activities. The open ended nature of health journals makes it possible to consider unanticipated factors, however, the non-selective and self-reported nature of health journals introduces data quality issues associated with user fatigue, recall and completion—users may inaccurately recall the details of an activity when they manually report it later, or may not report an activity at all because of the cumbersome nature of comprehensively reporting context.

Increased use of sensors in personal devices may shorten battery life and increased data costs. Some consumer products leverage sensor analytics in order to provide value to end users, but as the number and variety of sensors increase and apps leverage them more extensively, new challenges emerge that can introduce diseconomies for consumers. As a proxy indication for restful sleep, applications designed to analyze sleep patterns often use accelerometer sensors embedded in mobile devices to determine how often the user moves while sleeping. Other consumer offerings such as those designed to analyze golf club swing patterns feature an external sensor affixed to the club and linked to a mobile device via device-to-device protocols such as Bluetooth. These are examples of applications that may activate device sensors over several hours continuously and transmit payloads of data generated from the sensors to a remote server. As a result of these application behaviors, battery life of the devices can be reduced, and users may also incur additional data transmission fees.

### SUMMARY

In a preferred embodiment of the invention, a wearable device exposes data collected from biological and physics sensors to a software application that resides on the wearable device or on a device (or remote server) paired to the wearable device. The software application passively analyzes the sensor data over time as the user of the device freely engages in a variety of contexts and activities for which the application may not have any pre-existing awareness of. As the user does this, the software application monitors sensor data and applies conventional anomaly detection models to identify unusual patterns. In the event that an anomaly is detected, the software application applies conditional logic to determine whether similar patterns have been previously observed and whether any information has already been associated those patterns. If conditions are satisfied, the user is prompted to provide information on the context of those readings, such as what activity they were engaged in at the time, or other information. Once the user provides this context, the information is stored in order to enable future automatic context inferences for that user and for other users. The known context allows software applications to intelligently respond to users' activities by providing convenient options, or tracking activity over time.

In another embodiment of the invention, a public facing API is exposed which allows third party software applications that collect sensor data to request probable context of what activities or context a wearable device user might be engaged in at the time. The APIs query a relational database that is based on models established from aggregated anomalies detected in sensor data and associated conditional user facing context queries. Based on the request, the APIs can return one or more probable activity contexts. This understanding of the user's context allows the third party applications to use these inferences to perform a variety of tasks that are convenient or add value to their users.

In another embodiment of the invention, individuals seeking to improve their health and wellness (to the extent that health and wellness can be measured by bio sensors) may request a list of contexts or activities that they could engage in that are likely to yield their desired health outcome. As part of the query, the user indicates a desired health outcome and as part of their request and a list of activities or contexts are returned which are demonstrated through relationship models in the relational database to be associated with sensor readings which are indicative of the desired health outcome. The users' requests are initiated via a user interface on a portable device or website, and then queries are sent to a relationship database that stores associations of contexts, sensor readings, and health outcomes associated with the sensor readings.

In another embodiment of the invention, a software application that is installed on a mobile or wearable device conserves battery power of the device by selectively enabling or increasing the sampling frequency of sensors only when the additional sensor information is required. The application applies anomaly detection methods based on input from a primary sensor or sensors and then uses prompt logic to determine if a user should be prompted for additional information, the prompt logic also determines if additional sensors should be enabled or monitored at higher sampling rates. The additional sensor resources may be requested based on the user's response to a context inquiry. For example, if the user's response to a context inquiry indicated that an initial inference from a primary set of sensors was inaccurate, the additional sensor resources may then be requested to improve the accuracy of the inference.

### BRIEF DESCRIPTION OF THE DRAWINGS

FIG. 1 illustrates an embodiment of the varying activities of a software and hardware system stack over time as it performs the tasks associated with this invention.

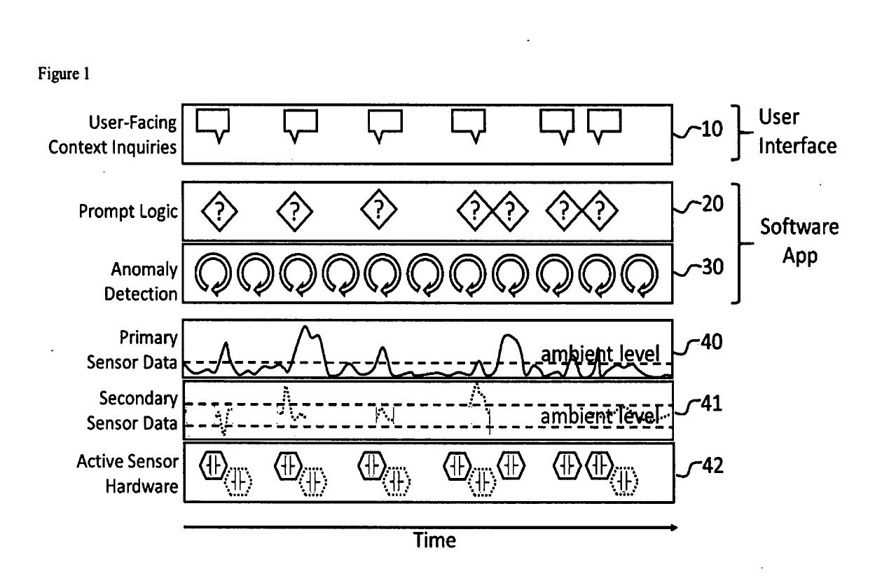

FIG. 2 illustrates the logical flow involved in reading and analyzing sensor data in order to detect anomalies, conditionally presenting context prompts, and associating response prompts to the anomalies

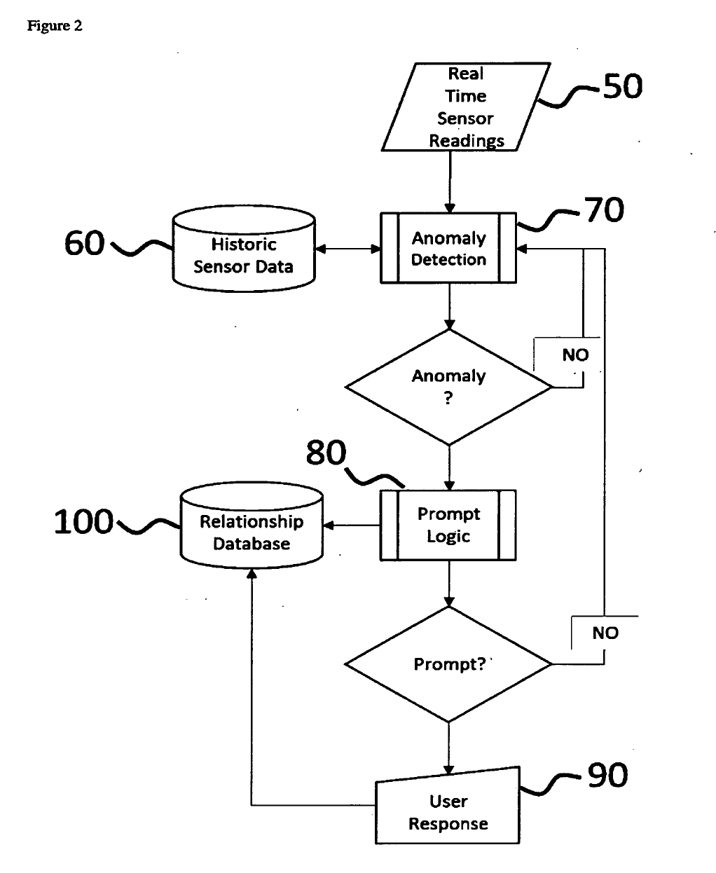

FIG. 3 describes a system and data exchange wherein a third party app that records sensor data sends sensor data as part of a request to a public facing API which returns contexts which models indicate could be indicated by the data

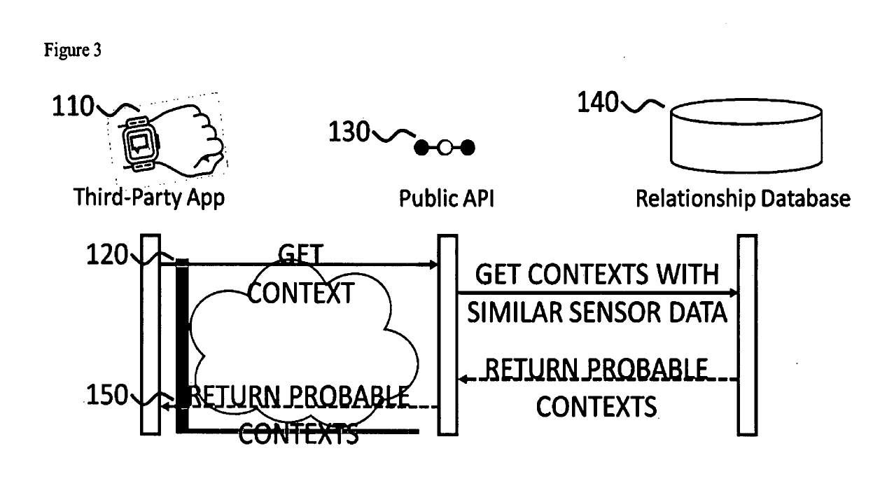

FIG. 4 describes a system and data exchange wherein wellness app or website allows a user to request contexts that have a high probability to help them achieve a specific wellness outcome

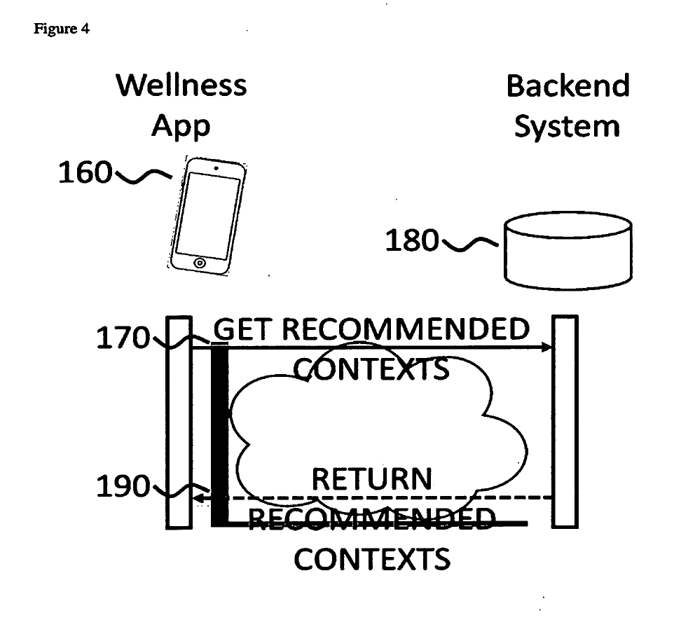

FIG. 5 presents they type of user facing recommendation that could be presented as a result of the system and data exchange described in FIG. 4

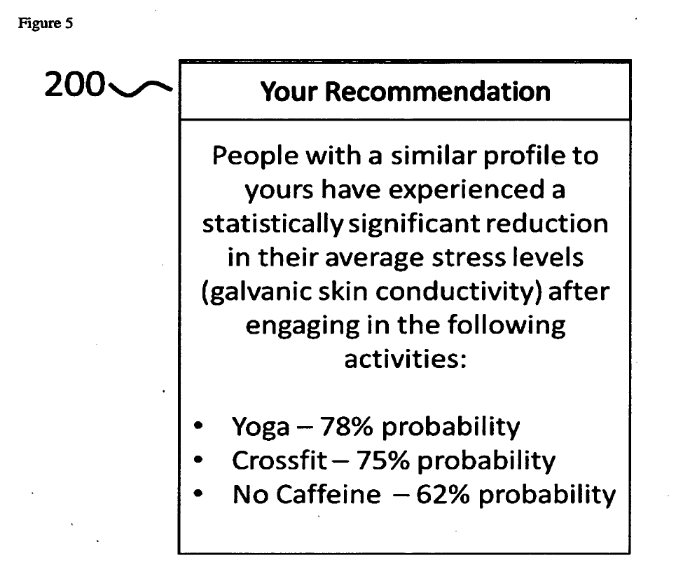

FIG. 6 presents one possible simplified database model for associating anomalies with responses to prompts and supplementary information

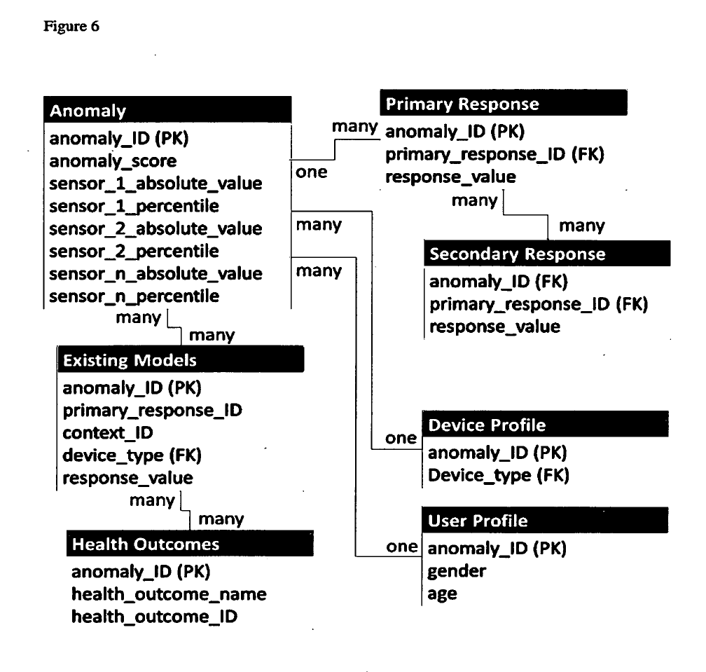

FIG. 7 illustrates a user facing ‘confirmation’ prompt that is initiated when a specific activity context is determined by the software with high probability

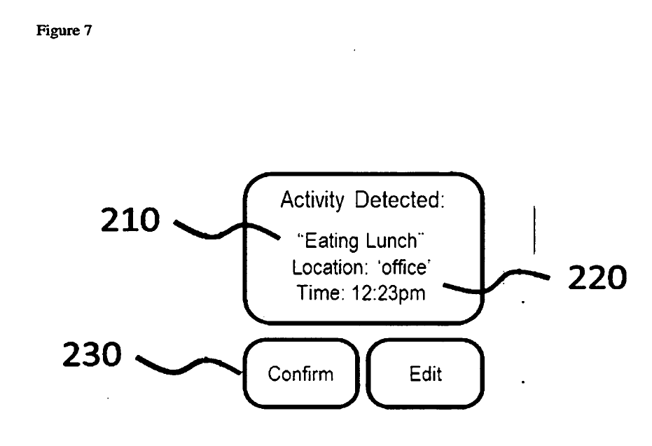

FIG. 8 illustrates a user facing ‘refinement’ prompt that is initiated when a general category of activity is determined but the user needs to indicate a specific activity

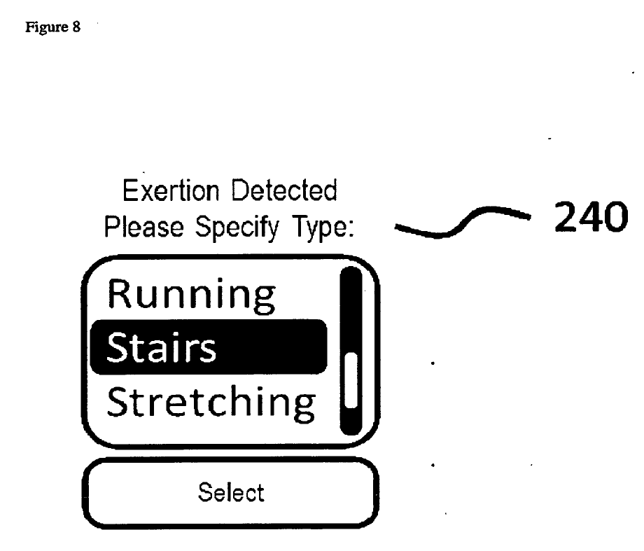

FIG. 9 illustrates a user facing prompt that is initiated when the software does not have a high probability determination of either the specific activity or the activity category

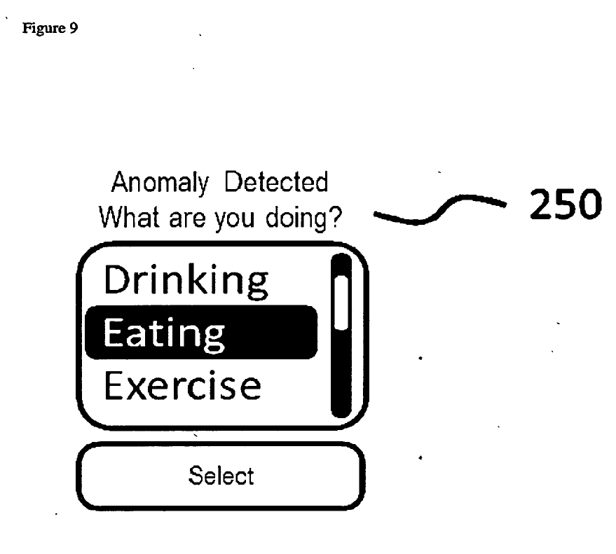

### DETAILED DESCRIPTION

The invention proposes a novel way to establish a contextual understanding of sensor readings for which the context is ambiguous and uncontrolled, and for which no pre-existing context-sensor relationships may exist in the system, in a manner that is user-friendly with respect to limiting the burden of user-input, mitigating data transmission costs and battery consumption through selective use of device resources.

An important contribution of the invention is a user-friendly process of appending supplemental context information to raw or abstracted sensor data, enabling the inference of meaning from the data without burdening the user with excessive or unnecessary requests. In addition to being user-friendly, the condition-based automatic prompting for user input associated with anomalies in sensor data reduces the potential for recall-induced data quality problems that can occur when queries are presented to users out of sequence or long after an event has occurred.

The user-friendly nature of the system is largely enabled through the selective presentation of user-facing prompts for which the frequency, timing and content is governed by a prompt logic layer. The prompt logic layer seeks to request the least possible amount of user input necessary to append context to data patterns. This is accomplished through a variety of methods such as checking whether context information already exists for similar data patterns in the individual's own data or from responses of other individuals. In the event of an anomaly in primary senor readings, the prompt logic layer may trigger the device to enable additional sensors (which may be normally disabled to conserve battery life) to collect additional data before prompting the user for input. As the user responds to prompts and contributes context information over time, the frequency of the prompts is reduced for habitual activities, thereby increasing the user-friendliness over time.

The context inquiries can be presented on the same device that gathers the sensor data, or on another device that can communicate directly or indirectly with the device that reads the sensor data, or a combination of both. To aid user recall, prompts may include information such as time of day, sensor readings (such as heart rate), and location information that could help users remember and more accurately report the context of that reading. Input methods for the user responses to the prompts can leverage a variety of input methods such as voice, haptic, gesture or motion.

Anomaly detection is considered prior art and not the focus of this invention. This invention works independently from existing or novel anomaly detection methods and the anomalies themselves can be identified through a variety of techniques. The presence of a known normal or ‘non-anomalous’ data set may or may not be necessary depending on whether supervised or unsupervised anomaly detection methods are applied, and the anomalies can be established relative to an individual user's own data or data from other individuals. Anomalies can be detected in a variety of ways such as the absolute or relative values of current to past sensor readings or the absolute or relative spread between current readings of different sensors. Anomalies can be stored in the system with any combination of absolute values or abstracted ‘scores’ or ‘signatures’ such as ‘hash values’.

In addition to storing anomaly information, the associated context derived from user responses must also be stored. The stored contexts can consist of either the raw responses or an abstracted context summary that is derived from one or more prompt responses. Known contexts can be stored as context IDs which are simply alpha numeric reference codes associated with a context, while new contexts gathered through open ended user input (such as a text field) are stored and transmitted as alpha string values.

Once anomalies have been identified and related user responses have been recorded and established as contexts, it is possible to apply a variety of modeling techniques to determine probabilistic relationships between contexts and data patterns. With the ability to cross reference anomaly data and user reported context in a relationship database, it is possible in subsequent cases to infer a likely context based on sensor data alone or combined with a reduced amount of user input using techniques such as Bayesian Inference. Context inferences can be made for multiple other individuals based on models established from sensor readings and responses from a single individual.

With this invention, it is also possible to reverse the inference inquiry. Instead of determining a probable context on the basis of sensor data anomaly patterns (that has already been associated with contexts responded from user reported inquiries), it is also possible to query for the biometric outcomes (such as reduced stress level readings) that have a probabilistic relationship to a specific context.

### Information About the Drawings

10 user facing context inquiries are the means by which requests for information are presented through a user interface to an individual whose device is capturing sensor data. The request and response methods and interfaces can be different. The figure depicts that occasionally a user facing context inquiry will not be presented as a result of a conditional decision made by the prompt logic layer 20

20 prompt logic applies a variety of pre-established thresholds and real time logical conditions to determine if a prompt should be presented, when it should be presented, what its content should be, whether follow on queries are needed, and whether additional information from the system or sensor should be requested or appended to the user response. The figure indicates that prompt logic is not necessarily constantly active, and is more of a function of the presence of anomalies. The figure also illustrates that prompt logic may determine that a user facing context inquiry should not be presented in some cases.

30 the anomaly detection layer reads and analyzes sensor data, It constantly evaluates sensor data from sensors that are activated and identifies unusual patterns in the data, pre-processing the data as patterns that can be referenced for later use throughout the system.

40 primary sensor data offer the most frequent readout and may be the main basis for anomaly detection. There may be more than one primary sensor. The information it exposes can be direct readouts from the sensor or it may be pre-processed

41 secondary sensor data may be conditionally triggered by the prompt logic layer 20 in order to append additional information to an anomaly or inform the prompt conditional logic

42 the sensor hardware layer depicted represents the conditional enabled state of primary and secondary sensor hardware

50 real time sensor readings include the raw, abstracted or fused (multiple readings combined into a single value or condensed set of values) sensor data that is made available to the software application

60 persistent storage of raw or abstracted sensor data that can be used to detect anomalies in real time sensor data

70 the anomaly detection process uses real time sensor data and optionally historic data to determine whether an anomaly is present. Anomalies are processed for later reference here

80 prompt logic is a set of rules and conditions that govern whether users are presented with context inquiries and also whether other system resources need to be accessed such as enabling additional sensors or requesting information from a server to associate information with a sensor anomaly

90 user responses are the actual user inputs to a context inquiry. User responses can be input in a variety of methods including gestures, touch interaction, voice, or use of physical buttons

100 a relationship database stores patterns in sensor data and user responses associated with those patterns with database ‘keys’ that provide for the association of these distinct sets of data. Additional information may be stored to assist the analysis of the data such as information about the device

110 software on a wearable device such as a smart watch. Although the image depicts a single worn device, the scope of the personal device for the purposes of this invention may consist of multiple units or devices that communicate with each other either via local protocol directly or indirectly via an intermediary system such as a server connected via internet

120 the wearable device software initiates a request for context to a public API. The request includes structured sensor data, meta information that can be used in the inference such as device type, user profile information, along with supplementary information necessary for the request handling

130 a public API is an interface that is exposed to any number of third party applications. The interface includes a network reference ID such as a URL and anticipates a specific type of structured input is provided in the request. The information returned is also provided in a pre-defined format

140 relationship database where associations between sensor data patterns and activity contexts are stored in a way that one side of the association can be referenced by the other

150 the context response contains references to any number of contexts that have a probability to be associated with the pattern of the sensor data included in the request. Each context reference returned in the response may have a numeric value or code indicating the probability that the context in the response is the one indicated by the sensor data included in the request

160 software or website on a mobile device or computer that helps users understand what types of contexts, activities or practices they can engage in in order to achieve a desired health or wellness outcome. The user would choose a desired outcome such as ‘reduced stress’ and potentially input profile information about themselves and then send a request to the system to return a list of recommended activities

170 the request sent to the backend from the software in 160 includes the desired outcome, which is translated by the software into a context ID, as well as profile information about the user

180 a relationship database contains information about user profiles, sensor data patterns, health outcomes types, and contexts that can be queried in any direction based on those criteria

190 based on the request in 170 and the result of the query conducted in 180 a backend system returns a set of recommended contexts the user could engage in that are likely to result in their desired health or wellness outcome, based on their profile information (age, gender, etc) and the degree to which those outcomes are associated with persons with a similar profile engaging in the reported contexts.

200 an example of a possible response to a request for recommended activity contexts that have been statistically indicative to yield a desired health outcome

210 when the software is able to identify an activity with high probability, it may only seek to have the user confirm the inference. Here the assessed context of “eating lunch” is displayed.

220 to aid in user recall, additional summary information about the anomaly instance is presented to the user. In this case a named location ‘office’ is shown as is the time of day. Location might be also represented as an address or a point or zone on a map.

230 when a context is assessed with high probability, users may only need to confirm the activity as opposed to indicating which activity they were engaged in

240 in the event that a broad category of activity is detected such as physical exertion, the software prompts the user for additional detail by asking them to select specific activities within the broader category (as opposed to having them sort through the universe of activities).

250 when an anomaly is detected for which there is no indication of what the related activity might be, the user is presented with a broader set of options to select from

### CITATIONS OF PRIOR ART

Alexander Chan, Ravi Narasimhan, “Automated sleep staging using wearable sensors” WO2015103558 A1, Jul. 9, 2015

Anurag Bhardwal, Neelkantan Sundaresan, Robinson Piramuthu “Recommendations based on wearable sensors” WO2014028765 A3, May 8, 2014

Soundararajarn Srinivasan, Aca Gacic, Raghu Kiran Ganti, “Activity monitoring device and method”, Sep. 23, 2010

John Stivoric “Device utilizing data of a user's context or activity to determine the user's caloric consumption or expenditure”, U.S. Pat. No. 8,708,904 B2, Apr. 29, 2014

Vamshi R. Gangumalla, Karthik Katingari, “Activity detection and analytics”, EP2868273 A1, May 6, 2013

Arpan Pal, “A system and method for identifying and analyzing personal context of a user”, WO2013118144 A2, Aug. 15, 2013

John Stivoric, “Predicted type and contexts in assessments”, US20140214874 A1, Jul. 31, 2014

Brian Clarkson, “Activity recognition apparatus, method and program”, U.S. Pat. No. 7,421,369 B2, Sep. 2, 2008

James M. A. Begole, “Method and system to predict and recommend future goal-oriented activity”, U.S. Pat. No. 7,882,056, Feb. 1, 2011

John Stivoric, “Providing recommendations based on the predicted context and type of individual as determined from a wearable device”, US20140213854 A1

David Martin, “Method and apparatus for mobile context determination”, US 20150018013 A1, Jan. 15, 2015

1. A method comprising: reading sensor data from a personal electronic device such as a mobile device, wearable, or dedicated personal sensor device;
analyzing the sensor data with software algorithms, where the objective of the analysis is to detect anomalies in sensor data ready by the device;
in the event of an anomaly detection, determining through a prompt logic layer whether to prompt the user for supplemental information associated with the anomaly;
presenting user-facing prompts according to conditional prompt logic; and
associating information about the anomaly and any related user responses to the prompts in a relational database.

2. The method of claim 1 where the nature of the prompt's human-machine interaction is any combination of visual, aural or haptic

3. The method of claim 1 where the prompt condition is whether a response to a previous prompt related to a similar anomaly has already been presented

4. The method of claim 1 where the prompt condition is whether a response to a previous prompt related to a similar anomaly has already been answered

5. The method of claim 1 where the prompt condition is influenced by algorithmic randomness

6. The method of claim 1 where the prompt condition is based on the content of the user's answer to a previous prompt about the same or similar anomaly

7. The method of claim 1 where the prompt condition is based on the degree to which the anomaly deviated from non-anomalous readings

8. The method of claim 1 where the prompt condition is based on the number of prompts already presented during a defined time period (absolute or average frequency)

9. The method of claim 1 where the prompt condition is based on the degree to which the anomaly triggering the prompt logic is similar to other anomalies for which prompts have already been presented

10. The method of claim 1 where the prompt condition is the beginning of a period of anomalous readings

11. The method of claim 1 where the prompt condition is exceeding or meeting a minimum time threshold during which absolute or average sensor values are consistently anomalous

12. The method of claim 1 where the prompt condition is absolute or average sensor readings returning to non-anomalous levels for a minimum time threshold

13. The method of claim 1 where the content of prompts is based on an initial inference of context instead of user responses

14. The method of claim 1 where the content of the prompts includes a summary of the sensor readings related to the anomaly

15. The method of claim 1 where the analysis is conducted to identify anomalies based on data from the same individual that is to be prompted

16. The method of claim 1 where the analysis is conducted to identify anomalies based on a comparison of the readings to data from multiple individual sensor users

17. The method of claim 1 where the association of prompt responses to anomalies contains information about the device or sensor the anomaly was identified on

[symbol]

18. The method of claim 1 where the association of prompt responses to anomalies contains meta information about the physical and temporal context of the readings such as time, date, duration, location, altitude, temperature, and others

19. A method comprising: predicting the probability that an individual is engaged in an activity contexts based on models created from associations of anomalies detected in sensor readings with user responses to conditional prompts associated with those anomalies

20. A method comprising adjusting data gathering frequency of sensors when a prompt logic layer determines based on a user response to a conditional prompt that additional data sampling is required
